(19) United States
(12) Patent Application Publication
(10) Pub. No.: US 2009/0173176 A1
(43) Pub. Date: Jul. 9, 2009

(54) MECHANICAL ADJUSTING DEVICE FOR ADJUSTING AN ADJUSTING ELEMENT

(76) Inventors: Friedrich Karrer, Horb (DE); Gundolf Kaupp, Horb-Altheim (DE); Marco Thurau, Waldachtal (DE)

Correspondence Address: MICHAEL J. STRIKER, 103 EAST NECK ROAD, HUNTINGTON, NY, 11743, US

(21) Appl. No.: 12/061,101

(22) Filed: Apr. 2, 2008

(30) Foreign Application Priority Data
Apr. 3, 2007 (DE) 10 2007 015 984.8

(51) Int. Cl. F16H 1/06

(52) U.S. Cl. 74/414

(57) ABSTRACT

The invention relates to a mechanical adjusting device for an adjusting element, for example an air flap (2) in an air channel (1) of a ventilation system in the passenger compartment of a motor vehicle. The mechanical adjusting device comprises two toothed wheels (5, 6) that mesh with one another, one of which wheels (6) comprises an operating wheel (17) and the other of which toothed wheels (5) is connected to an air flap so as to rotate therewith. By the overcoming of a pressure point created by a raised base (13) between two teeth, the air flap (2) is held in a closed position. The invention provides a stiffening element (15), for example in the form of a spoke, which braces the toothing (7) of one of the toothed wheels (5) in a chordal direction and thereby increases the bias with which the air flap (2) rests in position.

The invention relates to a mechanical adjusting device for adjusting an adjusting element having the features of the preamble of claim 1. “Adjusting” means a movement of the adjusting element, for example between an open position and a closing position. The adjusting element may be, for example, a slide member or a flap, for example, for allowing the passage of a fluid flow, throttling the fluid flow and closing it off. In particular, the adjusting device according to the invention is provided for controlling the ventilation system of a motor vehicle.

Such a mechanical adjusting device is known from Registered Design DE 20 2006 009 242 U1. The known adjusting device is provided for controlling an air flow in a ventilation device of a motor vehicle. It comprises as adjusting element a pivotable air flap, which is arranged in an air channel. The air channel is closed by positioning the air flap transversely across the air channel and is opened by positioning the air flap parallel to the air channel. In an oblique intermediate position the air flow in the air channel is throttled.

In order to adjust the air flap forming the adjusting element, the known adjusting device comprises toothed wheel gearing, the air flap being rigidly connected to one of the toothed wheels. Another toothed wheel comprises an operating wheel which projects through a slit in an instrument panel to enable it to be operated, that is to say rotated. The air channel is arranged on an inner side of the instrument panel or is part of a component of the instrument panel. By rotating or, more precisely, turning the operating wheel, the intermeshing toothed wheels and the air flap that is rigidly connected to one of the toothed wheels are pivoted, that is to say the air flap forming the adjusting element is adjusted.

Two toothed wheels of the toothed wheel gearing of the known adjusting device have an overcomable pressure point, that is to say an increased moment is required to turn the toothed wheels to overcome the pressure point. The pressure point is created by raising the base of the gap between the toothing of a toothed wheel so that, on rotation, the tip of a corresponding tooth of an intermeshing toothed wheel strikes the base of the gap between the teeth. At least one of the two intermeshing toothings is resilient so that the tooth tip striking the base of the gap between teeth and/or the base of the gap is able to yield. The pressure point is arranged at a position on the circumference of the toothed wheel that is reached shortly before the closed position of the adjusting element is reached. On closure, the pressure point is thus reached and overcome shortly before complete closure. Directly after it has been overcome, the pressure point creates a moment that causes the intermeshing toothed wheels to move away from the pressure point. When the pressure point has been overcome in the closing direction, the moment created by the pressure point acts upon the toothed wheels and by way of the toothed wheels moves the adjusting element to the closed position. As a result, the adjusting element of the known adjusting device in the form of an air flap is pressed with a bias against a step-shaped contact face arranged around the circumference of the air channel, as a result of which the air channel is reliably closed off and remains so. Loose fitting of the air flap forming the adjusting element against the contact face, including the possibility of a gap through which air might pass, is avoided.

In order to maintain the bias with which the adjusting element rests against the contact face in the closed position, the known adjusting device comprises a return-prevention stop with form-fit locking to prevent automatic unlocking, which return-prevention stop becomes effective once the adjusting element is pivoted to the closed position and the operating wheel is rotated a short distance further. Unlocking of the return-prevention stop is effected by turning the operating wheel back, that is to say by rotating the operating wheel in the opening direction.

The problem underlying the present invention is to propose a different way of maintaining the bias of the adjusting element of a mechanical adjusting device in the closed position or in a different end position.

The problem is solved according to the invention by the features of claim 1. The mechanical adjusting device according to the invention comprises two toothed wheels that mesh with one another to adjust, that is to say move, an adjusting element, the adjusting element being operatively connected to one of the two toothed wheels. The adjustment path of the adjusting element is limited in at least one direction by a limit, for example a mechanical stop. It is preferable but not obligatory for the limit to be effective in the closed position of the adjusting element. The drive is effected at or by way of the other toothed wheel.

The two intermeshing toothed wheels have an overcomable pressure point, which is created by raising the toothing of one or both of the toothed wheels. The raised height of the toothing, that is to say the overcomable pressure point, can be created by increasing the radius of the toothing, by making the distance between two teeth narrower, by raising the base of the gap between teeth or by raising the height of a tooth tip, that is by having a higher tooth at the pressure point. In order to allow for the raised height of the toothing, one of the two toothed wheels is resilient at least in the region of the overcomable pressure point in the direction of the tooth height. In the case of a radially toothed wheel, the direction of resilience is radial. The overcomable pressure point is arranged in such a manner that it is overcome immediately before the limit of the adjusting element is reached, so that the adjusting element rests with a bias against the limit. For the purpose of the invention, it is not important which of the two sets of toothing is resilient or whether both sets of toothing are resilient. It must be possible to overcome the pressure point with an appropriate operating force acceptable to the user, and the pressure point should give rise to a bias of the adjusting element against the limit.

The resilient construction of the toothing of one or both toothed wheels in the direction of the tooth height may reduce the resistance of the toothed wheel to torsion, that is to say the toothing is resilient not only as desired in the direction of the tooth height but also has resilience circumferentially around the toothed wheel. The invention provides stiffening of the resilient toothing against displacement in the circumferential direction of the toothed wheel, the stiffening being effective in the region of the pressure point and in the direction in which the adjusting element is pressed with a bias against the limit. Stiffness of the adjusting device according to the invention is increased at least in the direction of movement towards the limit and when the adjusting element reaches the limit. At a predetermined force for overcoming the pressure point or at a force exerted by virtue of the pressure point, the bias with which the adjusting element rests against the limit is increased.

Preferably the toothed wheels or at least one of the toothed wheels has toothing segments. The toothing of the toothed wheels thus does not extend around the entire circumference but only over a portion of the circumference. On the remaining portion of the circumference, the toothed wheel serving as drive member may, for example, have a gripping surface, which may, for example, be rubberized or corrugated.

To achieve the resilient construction of the toothing, an embodiment of the invention provides an aperture in the toothed wheel beneath the base of the teeth of the toothing. The aperture is provided at least where the toothing is to be resilient, that is to say in the region of the pressure point. The aperture may, for example, be an elongate hole extending beneath the base of the teeth in the circumferential direction. The toothed wheel may also have a hole punched in it between the toothing and the hub of the wheel or the toothing is carried on spokes. The stiffening according to the invention against displacement of the toothing in the circumferential direction spans the aperture of the toothed wheel starting from the region of the pressure point in a chordal direction of the toothed wheel. The stiffening thus extends from the pressure point in a chordal direction to the hub of the toothed wheel, namely in the direction in which the bias is exerted on the adjusting element. The stiffening is especially a rod-shaped stiffening element, for example like a spoke arranged in a chordal direction. That embodiment makes possible a toothed wheel that can be manufactured inexpensively in a single piece, for example, by injection-moulding from plastics.

In a preferred embodiment, the aperture in the toothed wheel extends in the circumferential direction in order to bring about the desired resilience of the toothing in the direction of the tooth height.

In a preferred embodiment of the invention, one of the toothed wheels comprises an operating wheel. The operating wheel may be arranged to rotate with the toothed wheel or, as already explained above, a portion of the circumference of the toothed wheel may be in the form of an operating wheel.

In particular, the mechanical adjusting device according to the invention is provided for or as part of a ventilation system in a motor vehicle. The adjusting element is an air flap which is arranged in an air channel and which closes the air channel in a closed position. The air flap is preferably pivotable and is rigidly connected to one of the two toothed wheels of the adjusting device according to the invention.

The invention will be explained hereinafter in greater detail with reference to an embodiment shown in the drawings, in which:

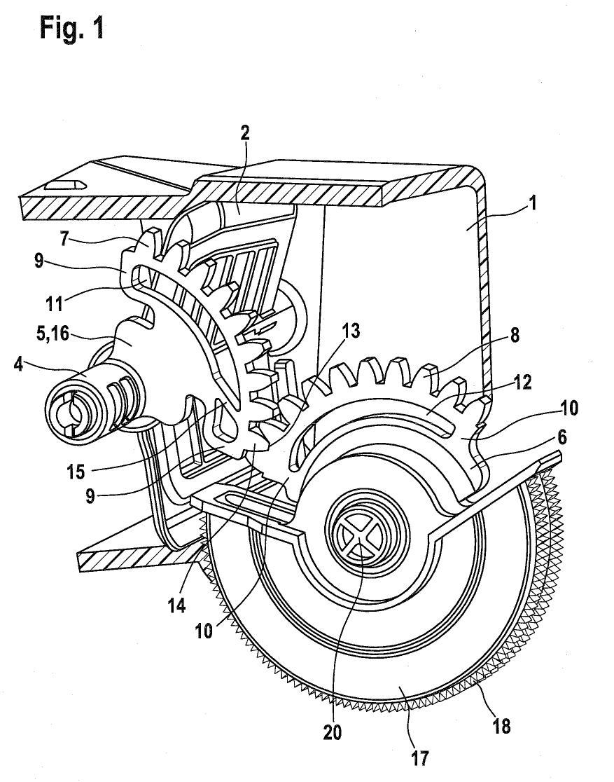

FIG. 1 is a perspective view, partially cut away, of an air channel of a vehicle ventilation system comprising a mechanical adjusting device according to the invention;

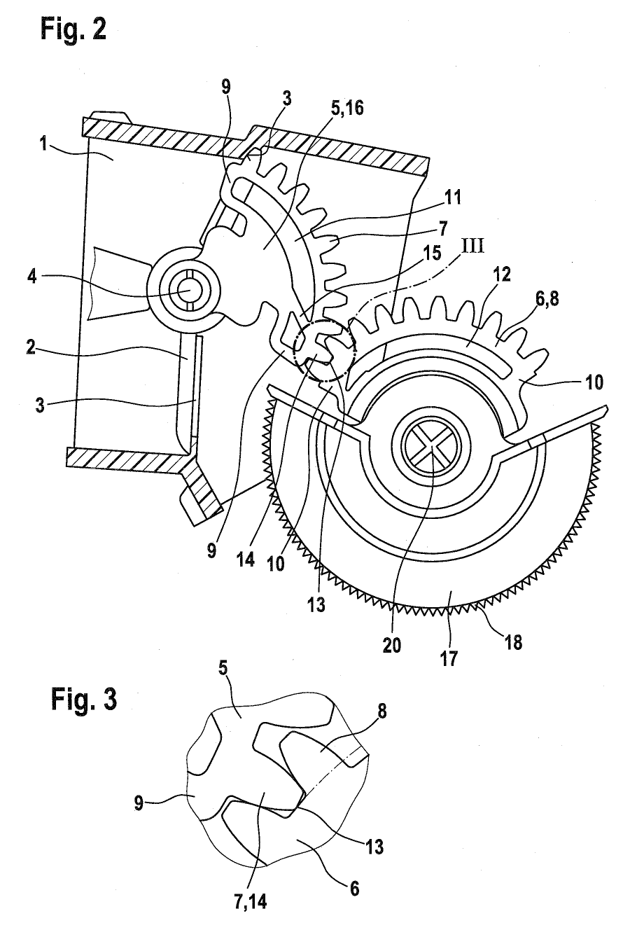

FIG. 2 is a side view of the adjusting device of FIG. 1; and

FIG. 3 shows a detail III from FIG. 2.

FIGS. 1 and 2 show an air channel 1 of a motor vehicle (not shown). Air passes through the air channel 1 to a heating, ventilation and/or air-conditioning system in the passenger compartment of a motor vehicle. The air channel 1 is rectangular in cross-section, although this is not obligatory. Arranged in the air channel 1 is an air flap 2, which is mounted to pivot about an axis that crosses the air channel 1 transversely. In the drawing the air flap 2 is shown in the position transverse to the air channel 1, that is to say in its closed position in which it closes the air channel 1. The air flap 2 is arranged to be pivoted about approximately 90° to an open position in which it is aligned approximately along the air channel 1. Intermediate positions are possible, in which the air flap 2 throttles air flow through the air channel 1. The air flap 2 forms an adjusting element of a mechanical adjusting device (still to be explained) according to the invention.

In the region of the air flap 2, the air channel 1 has a circumferential step which forms a stop 3 for the air flap 2 in its closed position. The stop 3 can also be described as a limit for the adjustment path of the air flap 2 in the closing direction. The stop 3 is interrupted and offset at a shaft 4 of the air flap 2 because the air flap 2, in the closed position, rests against the stop 3 at two different sides. The stop 3 limits the adjustment path of the air flap 2 forming the adjusting element in the closing direction, and so the stop 3 can therefore also be referred to as a limit for the adjustment path of the air flap 2. In addition to the air flap 2, the mechanical adjusting device according to the invention has two toothed wheels 5, 6 that mesh with one another and are arranged on the outside of a side wall of the air channel 1.

In the drawing the side wall of the air channel 1 is cut away so that the air flap 2 and its stop 3 are visible. One of the two toothed wheels 5 is arranged on the shaft 4 of the air flap 2 so as to rotate therewith. The other toothed wheel 6 is rotatably mounted on a stump shaft 20 that projects from the side wall of the air channel 1, which side wall is cut away in the drawing. The toothed wheels 5, 6 are radially toothed wheels and both have toothing segments 7, 8 which extend over a portion of the circumference of a little more than 90°. The toothing segments 7, 8 of the toothed wheels 5, 6, hereinafter referred to as toothings 7, 8, thus do not extend around the entire circumference, although the invention does not exclude this. The toothings 7, 8 of both toothed wheels 5, 6 are integral with their respective toothed wheels 5, 6 at both ends by way of radial spokes, 9, 10, respectively. Beneath the base of the teeth of the toothings 7, 8, apertures extend in the form of elongate holes 11, 12 in the circumferential direction of the toothed wheels 5, 6. In this manner the toothings 7, 8 are resilient in the radial direction, that is to say in the direction of the height of the teeth.

At one end of the toothing 8, the base 13 of the gap between two teeth is raised. That means, as shown by the broken line in FIG. 3, that the radius of the base of the gap at that mentioned position is greater than the radius of the base of the gaps between the other teeth of the toothing 8. The raised base 13 between two teeth means that a corresponding tooth 14 of the other toothed wheel 5 strikes the raised base 13 with the tip of its tooth. The resiliency of the toothings 7, 8 allows for the contact of the tooth 14 against the raised base 13. The raised base 13 between two teeth gives rise to a pressure point which can be overcome by rotating the two intermeshing toothed wheels 5,6 in either direction. The pressure point is so arranged that, when adjusting the air flap 2 in the closing direction, it is overcome shortly before the closed position is reached. In the closing position, the pressure point exerts a moment that presses the air flap 2 against the stop 3 with a bias, that stop 3 forming a limit for the adjustment path in the closing direction.

Owing to their resilient construction, the toothings 7, 8 are resilient not only as desired in the radial direction, that is to say in the direction of the tooth height, but also undesirably in the circumferential direction. It is possible for the toothings 7, 8 to be resilient in the circumferential direction but the resistance of the toothed wheels 5, 6 to torsion is reduced. For that reason, one of the two toothed wheels 5, 6 has stiffening against displacement of its toothing 7 in the circumferential direction. In the embodiment, the stiffening is a rod-shaped stiffening element 15 arranged to extend in a chordal direction of the toothed wheel 5. The stiffening element 15 connects the toothing 7 to a wheel disk 16 of the toothed wheel 5, which wheel disk is arranged to rotate with the shaft 4. The stiffening element 15 spans the elongate hole 11 that forms the aperture in the toothed wheel 5. The stiffening element 15 starts in the region of the base of the tooth 14 of toothing 7 that co-operates with the raised base 13 between two teeth of toothing 8 of the other toothed wheel 6 and creates the overcomable pressure point. From the mentioned tooth base, the stiffening element 15 extends in a direction that causes the bias with which the air flap 2 forming the adjusting element rests against the stop 3 in the closed position. The stiffening element 15 can also be in the form of a spoke of the toothed wheel 5 arranged in a chordal direction. As explained, the stiffening element 15 braces the toothing 7 against displacement in the circumferential direction, namely in the closing direction, as a result of which the bias with which the air flap 2 rests against the stop 3 in the closed position is increased. Higher bias results in a good closing action of the air flap 2. An air gap between the closed air flap 2 and the stop 3 as a result of too little or absent bias is avoided. Moreover, rattling noises from the closed air flap 2 are also avoided. Stiffening of the toothing 8 against displacement in the circumferential direction can in principle be provided also on the other toothed wheel 6 or on both toothed wheels 5, 6.

The other toothed wheel 6 comprises an operating wheel 17. The operating wheel 17 is arranged to rotate with the toothed wheel 6 and extends over a portion of the circumference in which there is no toothing 8. The operating wheel 17 has corrugation 18 around its circumference as a gripping surface.

1. Mechanical adjusting device for adjusting (moving) an adjusting element (2), the adjustment path of which has a limit (3) at least in one direction, comprising two intermeshing toothed wheels (5, 6), which mechanical adjusting device has an overcomable pressure point created by raising the toothing (13) of one of the two toothed wheels (6) directly before the limit (3) of the adjusting element (2) is reached, so that the adjusting element (2) rests with a bias against the limit (3), the toothing (7, 8) of one of the two toothed wheels (5, 6) being resilient in the direction of the tooth height in order to allow for the raised toothing (13) of that toothed wheel or of the other toothed wheel (5), characterized in that the resilient toothing (7) has stiffening (15) against displacement of the toothing (7) in the circumferential direction of the toothed wheel (5) in the region of the pressure point.

2. Mechanical adjusting device according to claim 1, characterized in that at least one of the two toothed wheels (5, 6) has toothing segments (7, 8).

3. Mechanical adjusting device according to claim 1, characterized in that the toothed wheel (5, 6) having the resilient toothing (7, 8) comprises an aperture (11, 12) beneath the base of the teeth of its toothing (7, 8) and that the stiffening (15) spans the aperture (11) starting from the region of the pressure point in a chordal direction.

4. Mechanical adjusting device according to claim 3, characterized in that the stiffening comprises a rod-shaped stiffening element (15) that extends in a chordal direction of the toothed wheel (5).

5. Mechanical adjusting device according to claim 3, characterized in that the aperture (11, 12) extends in the circumferential direction of the toothed wheel (5, 6).

6. Mechanical adjusting device according to claim 1, characterized in that one toothed wheel (5) includes a raised base (13) between two teeth to raise the toothing.

7. Mechanical adjusting device according to claim 1, characterized in that one toothed wheel (6) comprises an operating wheel (17).

8. Mechanical adjusting device according to claim 1, characterized in that the adjusting element is an air flap (2).

9. Mechanical adjusting device according to claim 8, characterized in that the air flap (2) is rigidly connected to one of the two toothed wheels (5).
